(19) United States
(12) Patent Application Publication
(10) Pub. No.: US 2006/0211453 A1
(43) Pub. Date: Sep. 21, 2006

(54) System for dialing a telephone number stored in a mobile electronic device when the device is away from its home calling area

(76) Inventor: Andrew N. Schick, Lawrenceville, GA (US)

Correspondence Address: NEEDLE & ROSENBERG, P.C., SUITE 1000, 999 PEACHTREE STREET, ATLANTA, GA, 30309-3915, US

(21) Appl. No.: 11/080,136

(22) Filed: Mar. 15, 2005

(51) Int. Cl. H04M 3/00; H04B 1/38

(52) U.S. Cl. 455/564; 455/418; 455/432.1; 455/550.1

(57) ABSTRACT

A system for dialing telephone numbers stored in a mobile electronic device when the device is in away from a home calling area is described. The system has a memory element, microprocessor, and a transceiver element. The memory element is operable for storing the telephone number, a travel profile, and location dialing software, which is operable for prompting the memory element to generate dialing instruction signals associated with the travel profile. The microprocessor is operatively coupled to receive the dialing instruction signals from the memory element and generates dialing signals in response to receiving the dialing instruction signals. The transceiver element is coupled to receive the dialing signals and is operable for dialing the telephone number when the mobile electronic device is away from the home calling area. In an alternative implementation, the system may include a caller identification feature.

### BACKGROUND

With the increasing availability of efficient, low cost electronic modules, mobile electronic devices are becoming more widespread. For example, the general availability of personal digital assistants (PDAs) and portable communication devices, such as wireless telephones, are making these devices more popular. Regular use of mobile electronic devices may result in an excessive amount of telephone numbers stored in these devices, which correspondingly produces internal telephone books with large amounts of data. In storing these numbers, a user may only enter the numbers necessary for dialing from his home location. For example, a user that resides in a city with only seven digit dialing may only enter seven digits.

Because mobile electronic devices are by their nature portable, users often desire utilizing them in remote locations, such as when traveling. Using these devices in locations other than the device's home calling area may necessitate compliance with certain dialing conventions. For example, international calling requires entering a country code. These dialing conventions can make telephone numbers stored in the mobile electronic device unusable when the device is in a location other than its home calling area.

Therefore, there is a need for a mobile communication device that is easily usable from all calling areas.

### SUMMARY

Embodiments of the invention include a system for dialing telephone numbers stored in a mobile electronic device when the device is away from its home calling area. The system has a memory element, a microprocessor, and a transceiver. The memory element is operable for storing the telephone number, a travel profile, and location dialing software, which is operable for prompting the memory element to generate dialing instruction signals associated with the travel profile. The microprocessor is operatively coupled to receive the dialing instruction signals from the memory element and generates dialing signals in response to receiving the dialing instruction signals. The transceiver element is coupled to receive the dialing signals and is operable for dialing the telephone number when the mobile electronic device is away from its home calling area.

Related methods of operation and computer readable media are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts or blocks throughout the different views.

FIG. 1 is a block diagram illustrating a mobile electronic device constructed in accordance with the invention.

FIG. 2A is a black diagram illustrating a number of comparison digits selection menu for the display of FIG. 1.

FIG. 2B is a block diagram illustrating a travel profile selection menu for the display of FIG. 1.

FIG. 3 is a flow chart illustrating and algorithm that describes the operation of location dialing software of FIG. 1.

FIG. 4 is a flow chart illustrating the incoming call subroutine of FIG. 2A.

FIG. 5 is a flow chart illustrating the outgoing call subroutine of FIG. 2A.

FIG. 6 is a flow chart illustrating the optional profile selection subroutine of FIG. 5.

### DETAILED DESCRIPTION

While described below as being particularly applicable to a portable communication handset, such as a cellular-type telephone, or a personal digital assistant (PDA), the system for dialing telephone numbers stored in a mobile electronic device when the device is away from a home calling area is applicable to any mobile electronic device in which it is desirable to dial when the device is away from a home calling area.

The system for dialing telephone numbers stored in a mobile electronic device when the device is away from a home calling area can be implemented in software, hardware, or a combination thereof. In one embodiment, selected portions of this system are implemented in hardware and software. The hardware portion can be implemented using hardware logic. The software portion can be stored in a memory element and can be executed by a suitable instruction execution system (microprocessor). The hardware implementation can include any or a combination of the following technologies, which are all well known in the art: a discrete logic circuit(s) having logic gates for implementing logic functions upon data signals, an application specific integrated circuit (ASIC) having appropriate logic gates, a programmable gate array(s) (PGA), a field programmable gate array (FPGA), etc.

The software portion is referred to as location dialing software, which is described in greater detail below. The location dialing software, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer-readable medium can be, for example, but, not limited to, an electronic, magnetic, optical, electromagnetic, infrared, or semiconductor system, apparatus, device, or propagation medium. More specific examples (a non-exhaustive list) of the computer-readable medium can include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium can even be paper or another suitable medium upon which the program is printed. The program can be electronically captured, via for instance optical scanning of the paper or other medium, then compiled, interpreted or otherwise processed in a suitable manner if necessary, and then stored in a computer memory.

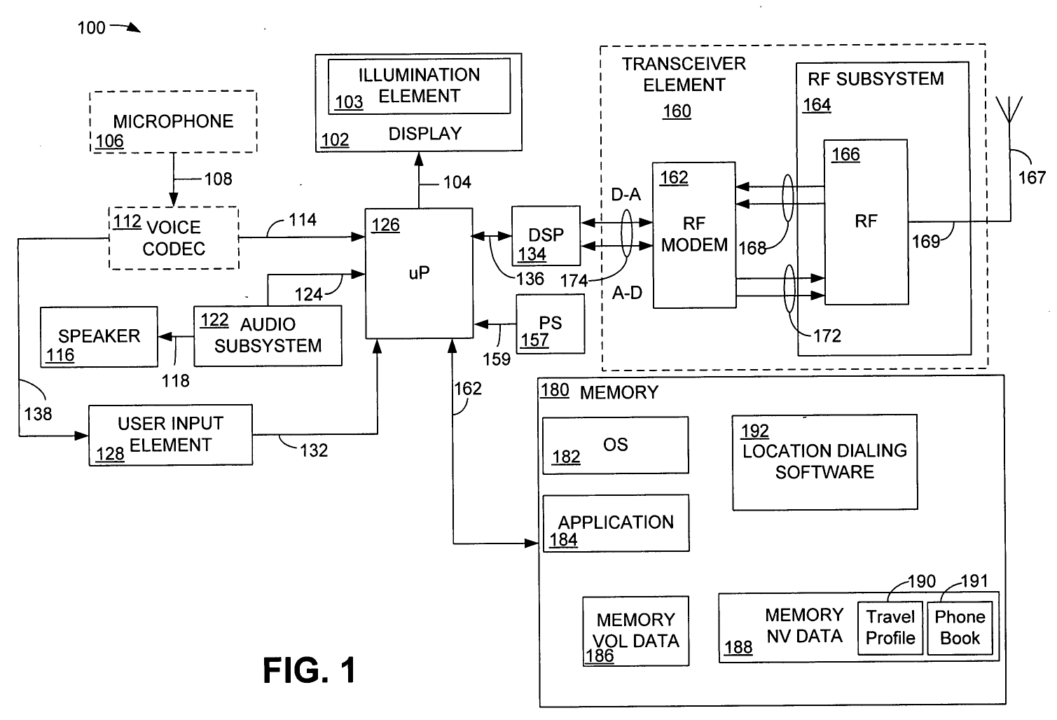

FIG. 1 is a block diagram illustrating a mobile electronic device 100 constructed in accordance with an embodiment of the invention. The mobile electronic device 100 generally includes a microprocessor 126 coupled to a memory element 180 via connection 162. The microprocessor 126 is also coupled to a display element 102 via connection 104, a digital signal processor (DSP) 134 via connection 136, and a power source 157 via connection 159. The display element 102, if illuminated, may include an illumination element 103.

The memory element 180 can include any one or a combination of volatile memory elements (e.g., random access memory (RAM), such as DRAM, SRAM, etc.)) and non-volatile memory elements (e.g., RAM, ROM, hard-drive, tape, CDROM, etc.). Moreover, the memory element 180 may incorporate electronic, magnetic, optical, and/or other types of storage media. Note that the memory element 180 can have a distributed architecture, where various components are situated remotely from one another, but are accessible by the microprocessor 126.

The microprocessor 126 can be any special purpose or general purpose processor capable of executing the instructions contained in the software (to be described below) contained within memory element 180.

The mobile electronic device 100 also includes a user input element 128 that is coupled to the microprocessor 126 via connection 132. The user input element 128 can be, for example but not limited to, a keypad, stylus and screen, a trackball, a touch-sensitive pad, a finger actuated pointer device, a microphone, such as microphone 106, (optionally shown coupled to the user input element 128 through a voice coder/decoder (codec) 112 via connection 138), or any other interface for communicating user commands to the microprocessor 126. For example, if the mobile electronic device 100 is a cellular-type mobile telephone, the user input element 128 may include a keypad for entering alphanumeric characters. If the mobile electronic device 100 is, for example, a PDA, then the user input element 128 can be a combination of a keypad, mouse, and a stylus for marking notations on an input screen. One skilled in the art will appreciate that the user input element 128 can be used to initiate any basic calling operations, such as dialing a telephone number.

The mobile electronic device 100 also includes an audio subsystem 122 and a speaker 116. The audio subsystem 122 is coupled to the microprocessor 126 via connection 124 and supplies an audio signal on connection 118 to the speaker 116. If the mobile electronic device 100 is a portable communication handset, the speaker 116 may be the speaker that the user places to his or her ear in order to listen to a voice conversation. If the mobile electronic device is a PDA, then the speaker 116 can provide audible output to the user. Furthermore, although omitted for simplicity, the audio subsystem 122 may also provide an interface to a headset type speaker device while the user input element 128 may provide an interface to a microphone so that the mobile electronic device 100 can be used with a portable headset.

If the mobile electronic device 100 is, for example, a portable cellular-type telephone handset, then it can also include a microphone 106, a voice coder/decoder (codec) 112 and a transceiver element 160. The microphone 106 is coupled to the voice codec 112 via connection 108. The microphone converts audible sound energy into an electrical signal that is processed by the voice codec 112 and forwarded via connection 114 to the microprocessor 126. The microprocessor 126 processes the input on connection 114 as known to those having ordinary skill in the art.

The DSP 134 is coupled to the transceiver element 160 via connection 174. The connection 174, while shown as two bi-directional communication lines, may also include the digital-to-analog and analog-to-digital conversion used to transmit and receive information using the transceiver element 160 (omitted from FIG. 1 for simplicity). The transceiver element 160 includes a radio frequency (RF) modem 162, coupled via connections 168 and 172 to RF electronics element 166. When the modem 162 receives a transmit signal from the DSP 134 over connection 174, it produces a corresponding RF transmit signal over connection 172. The RF electronics element 166 represents one or more components that process a modulated RF transmit signal received from the RF modem 162 via connection 172 and provide a received RF signal to the RF modem 162 via connection 168. The RF electronics element 166 couples to the antenna 167 via connection 169. The RF electronics element 166 includes the components necessary to upconvert, transmit, receive and down convert an RF signal. The RF modem 162 modulates the RF signal prior to sending the signal to the RF electronics element 166 and demodulates a received signal from the RF electronics element 166. The demodulated received signal is transmitted to the DSP 134 via connection 174. The DSP 134 produces a corresponding digital received signal and transmits it to the microprocessor 126 via connection 136.

As mentioned above, if the mobile electronic device 100 is a cellular-type telephone, then the transceiver element 160 includes all the elements used to receive a digital-to-analog converted signal via connection 174 and transmits that information using radio frequency energy. Similarly, the transceiver element 160 also includes all the circuitry used for receiving a radio frequency signal, and providing that signal via connection 174, for analog-to-digital conversion, to DSP 134 and then to the microprocessor 126.

In accordance with an embodiment of the invention, the mobile electronic device 100 includes a memory element 180 for storing the travel profile 190. As mentioned above, the memory element 180 may include volatile memory elements, volatile (VOL) data memory 186, volatile memory elements and nonvolatile (NV) data memory 188. The travel profile 190 may be located within the NV data 188. The memory element 180 also includes the location dialing software 192, which accesses the travel profile 190 and the telephone book 191 when appropriate as further explained below.

The software in memory element 180 may include one or more separate programs, each of which comprise one or more code segments, which are an ordered listing of executable instructions for implementing logical functions. In the example of FIG. 1, the software in the memory element 180 includes an operating system 182, application software 184, and location dialing software 192. The application software 184 is executed by the microprocessor 126 in order to perform task specific operations of the mobile electronic device 100. The location dialing software 192 includes the software code segments that are executed by the microprocessor 126 or another device for placing and receiving calls when the mobile electronic device 100 is in a location other than its home calling area. Hence, the location dialing software 192 may transmit either dialing instruction signals or identification instruction signals to the microprocessor 126.

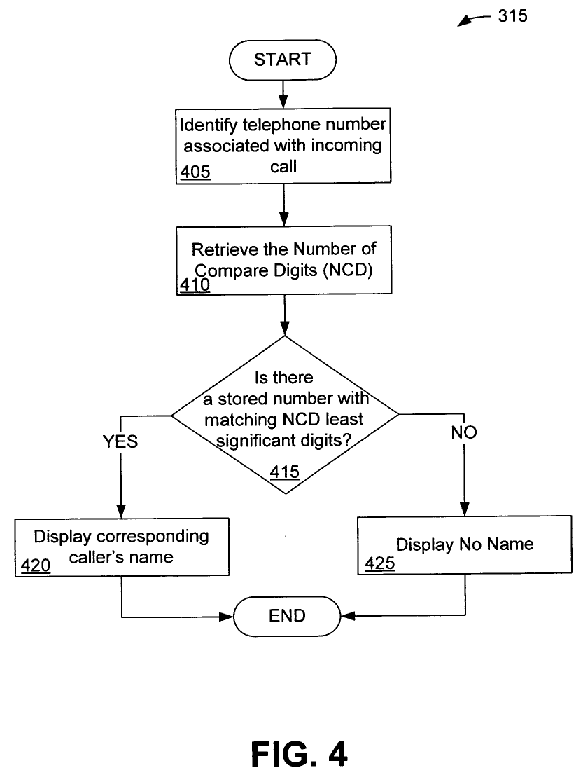

When the microprocessor 126 receives the dialing instruction signals, it sends dialing signals to the DSP 134 via connection 136. In response, the DSP 134 produces a transmit signal that is sent to the transceiver element 160 on connection 174. The transceiver element 160 processes this signal as previously described. The dialing instruction signals are further described with reference to FIG. 4.

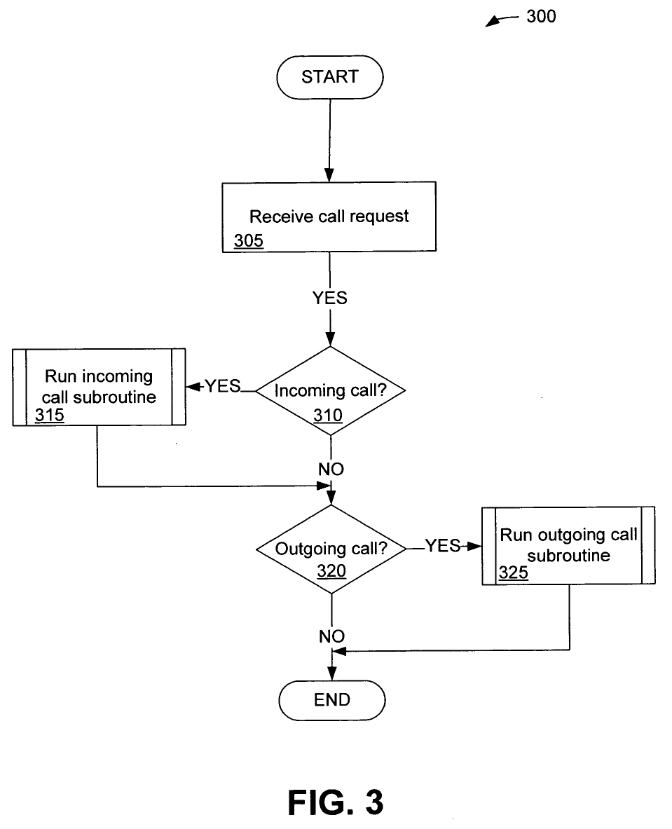

The microprocessor 126 transmits display signals on connection 104 when it receives identification instruction signals from the location dialing software 192. As mentioned above, the microprocessor 126 is coupled to the display element 102 via connection 104. Hence, the microprocessor 126 produces content for viewing by the user using the display signals. The identification instruction signals and corresponding display signals are described with reference to FIG. 3.

With respect to the operating system 182, any available operating system that can be used to execute the normal functionality of the mobile electronic device 100 can be used. For example, if the mobile electronic device 100 is a PDA, a suitable operating system can be the Windows CE operating system, available from Microsoft Corporation of Redmond, Wash. If the mobile electronic device 100 is a cellular-type mobile communication device, then the operating system 182 may be a proprietary operating system designed by the manufacturer of the device 100.

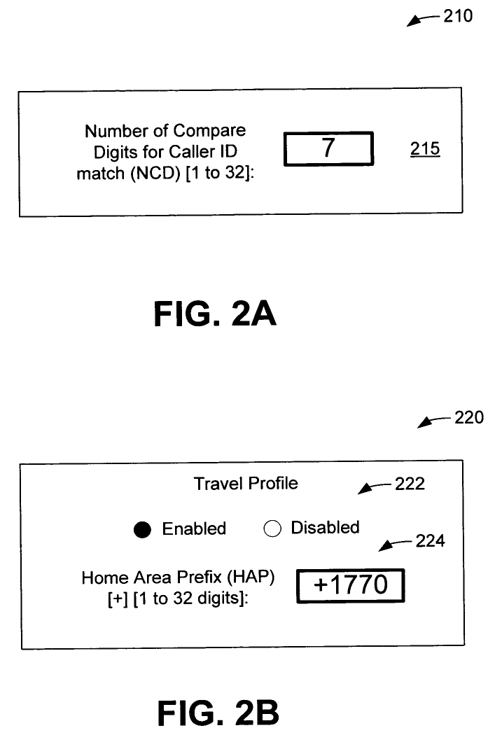

With the display 102, a user may specify certain criteria that affect the use of the mobile electronic device 100. More specifically, the number of comparison digits (NCD) selection menu 210 shown in FIG. 2A may be presented on the display 102, which enables selection of the NCD. When a user specifies the NCD, the user is specifying how many digits the location dialing software 192 should use in attempting to identify an entry in the telephone book 191 that is associated with an incoming call. When a user specifies the NCD, this number may appear in the selection box 215. For example, an NCD of 5 means that the location dialing software 192 compares five digits of the telephone number associated with the incoming call to five digits for each entry within the telephone book 191. The use of the NCD is described in greater detail with reference to FIG. 4. Though not shown, the location dialing software 192 may use a default NCD, such as 7, if a user does not specify an NCD or if the specified NCD is not recognizable. This default may be preset during manufacturing customization to satisfy requirements of a particular customer. The NCD may vary between one and thirty-two digits, two and sixteen digits, or some other suitable range. Once the NCD is assigned, it remains constant until a user enters the NCD selection menu 210 and changes the NCD.

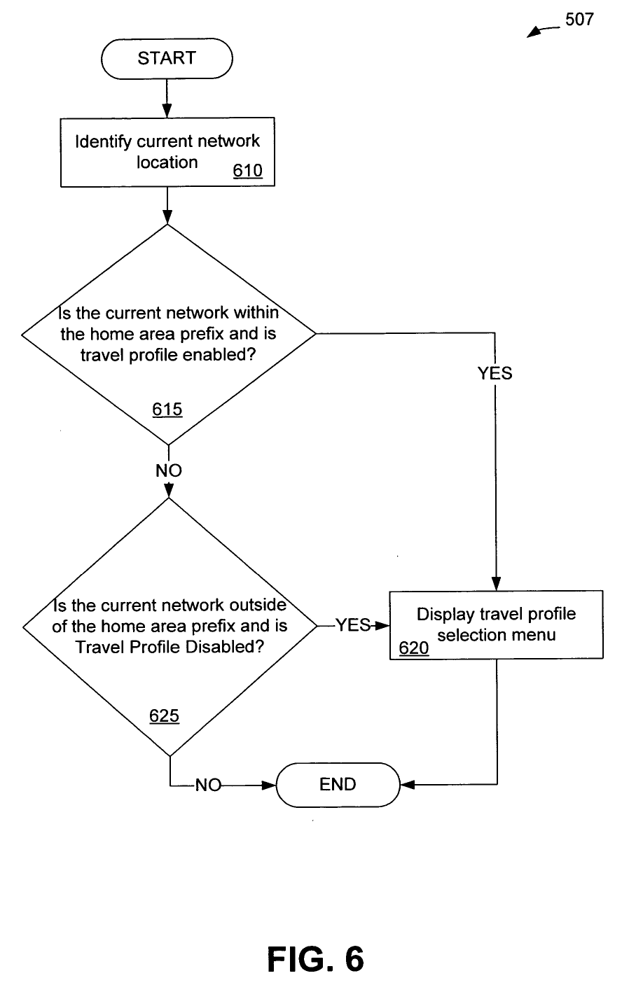

The display 102 may also depict a travel profile selection menu 220 used in either enabling or disabling the travel profile 190. To access this menu, a user may either navigate to this menu or be prompted, as described with reference to FIG. 6. Using the toggle 222, a user may either enable or disable the travel profile 190. In one embodiment, the mobile electronic device 100 may have a default state where the travel profile 190 is disabled.

In addition to either enabling or disabling the travel profile, the travel profile selection menu 220 may be used in specifying a Home Area Prefix (HAP). As a user enters a HAP, it appears within the box 224, such as +1770. A HAP may be a collection of alphanumeric characters or symbols placed before the telephone number that are used in satisfying dialing conventions. In an alternative embodiment, the travel profile selection menu 220 may include an additional box where a user may enter a travel destination instead of a HAP. In other words, the location dialing software 192 interprets the information received from the user as a travel destination and attempts to generate the appropriate HAP. This may be done by comparing the information to a list of travel destinations in tables within the memory element 180. If it is determined that the entered information is not recognizable, a message to the user may be displayed, such as, “reenter destination or prefix,” or some other suitable message that will prompt a user to reenter information.

If a destination is recognizable, the mobile electronic device 100 may download via the transceiver element 160 a home area prefix associated with the identified destination. Alternatively, the mobile electronic device 100 may use the memory element 180 for storing home area prefixes for major countries, as well as regions within the United States.

Though not shown, the travel profile selection menu 210 may also include a selection box for enabling a caller identification feature. Hence, a user may specify whether he or she wants identification information displayed, for incoming calls originating from telephone numbers corresponding to entries within the telephone book 191, while in the identified travel destination. To indicate whether the caller identification function is enabled, a call identification indicator may be used. In an alternative embodiment, a default may be set that enables the caller identification feature. In another alternative embodiment, the caller identification feature may be omitted completely.

FIG. 3 is a flow chart 300 illustrating an algorithm that describes the operation of the location dialing software 192. Any process descriptions or blocks in flow charts can be understood as representing modules, segments, or portions of code which may include one or more executable instructions for implementing specific logical functions or blocks in the process. Alternative implementations are included within the scope of the invention in which functions may be executed out of order from that shown or discussed, including substantially concurrently or in reverse order, depending on the functionality involved, as can be understood by those reasonably skilled in the art.

In block 305, the location dialing software 192 receives a call request. This request may result from a user selecting a number from the telephone book 191 and then selecting a dial operation using the user input element 128. Alternatively, this request may be generated when an incoming call is received by the mobile electronic device 100, as previously described.

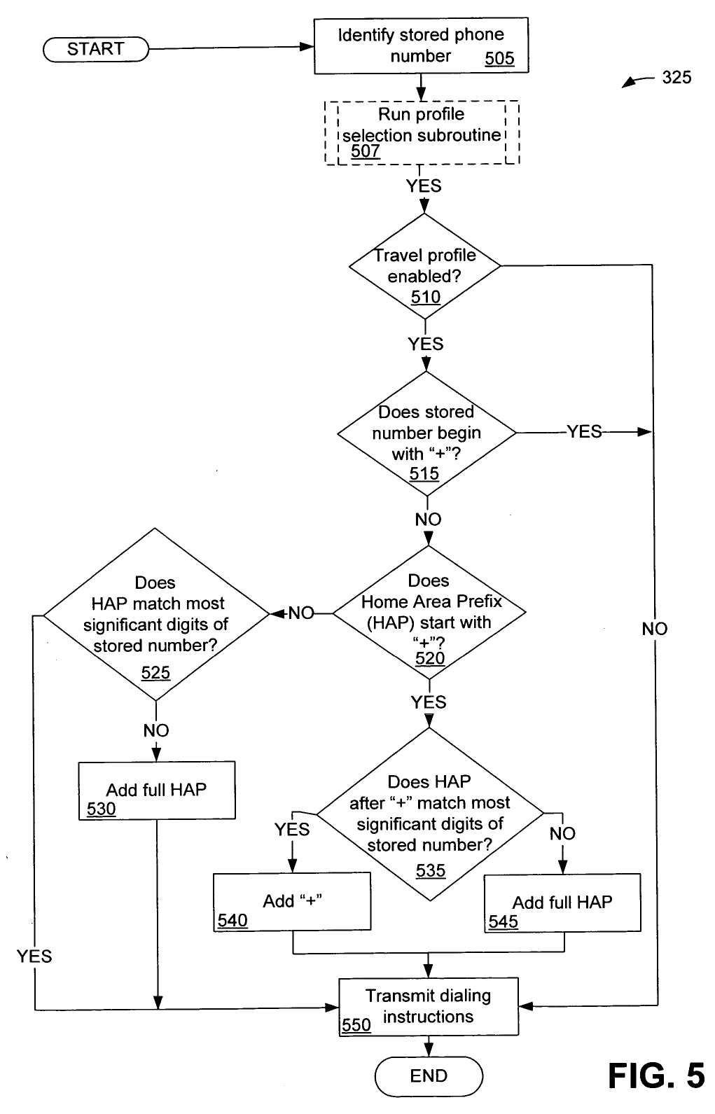

In block 310, it is determined whether the call request corresponds to an incoming call. If the call is an incoming call, then in block 315 an incoming call subroutine is run, which is described in greater detail below with reference to FIG. 4. If the call request is not an incoming call, then in block 320 it is determined whether the call request received in block 305 corresponds to an outgoing call. If the call is an outgoing call, then in block 325, an outgoing call subroutine 325 is run, which is described in greater detail with reference to FIG. 5.

FIG. 4 is a flow chart 315 illustrating the incoming call subroutine 315 described with reference to FIG. 3. The incoming subroutine 315 enables a user to identify a stored telephone number associated with an incoming call even when the mobile electronic device 100 is in a location other than a home calling area. A user can identify whether an incoming call is from one of the telephone numbers stored in the telephone book 191.

The incoming call subroutine 315 begins at block 405 where the location dialing software 192 identifies the telephone number associated with the incoming call. The internal telephone book 191 can be searched in its entirety until a match is either found or the search is completed.

In block 410, the number of comparison digits (NCD) is retrieved. As mentioned above, the NCD may be specified by a user as described in FIG. 2A. In block 410, the number of comparison digits previously specified by a user is retrieved. In block 415, the least significant digits of the stored entries are compared to the least significant digits of the identified telephone number. For example, specifying five digits as the number of comparison digits results in the least significant five digits in the incoming telephone number serving as the basis for comparison. Those five digits are then compared to the five least significant digits of each stored telephone number.

When there is at least one stored number with matching least significant digits, an incoming call entry is displayed in block 420. Displaying the entry may include displaying the stored telephone number. Alternatively, this may involve displaying the name associated with the entry instead of, or in addition to, displaying the telephone number. In another alternative embodiment, displaying the entry may involve displaying some other information that the user associated with the entry, such as a picture, or a movie, or a particular sound or tune might also be sounded. To display the entry, the location dialing software 192 transmits identification instruction signals to the microprocessor 126, which transmits display signals for the display 102.

When at least one stored number with matching least significant digits is not identified, the message, “No Name” may be displayed in block 425 in a manner similar to that described with reference to block 420. A user can choose whether to answer the call since he knows it is not from an individual associated with one of the telephone numbers stored in the phone book 191. Alternatively, nothing could be displayed, or only the incoming number might be displayed. In another alternative embodiment, another message, such as “Caller Unknown,” or a user selected message, such as “Do not answer,” is displayed. If a user-selected message is used, this message may also be specified using the travel profile selection menu 220 described with reference to FIG. 2B. After either block 420 or block 425 is completed, the incoming call subroutine 315 ends.

FIG. 5 is a flow chart 325 illustrating the outgoing call subroutine 325 described with reference to FIG. 3. The outgoing call subroutine 325 enables a user to dial telephone numbers stored in the mobile electronic device 100 when this device is in a location other than a home calling area. The outgoing call subroutine 325 facilitates dialing conventions that are required when the mobile electronic device 100 is in a location other than a home calling area for dialing numbers within the telephone book 191.

In block 505, a stored telephone number is associated with the outgoing call. To accomplish this, the location dialing software 192 may associate a number selected by a user with an outgoing call. In an alternative embodiment, the flow chart 325 may include a block 507, which runs a profile selection subroutine that is described with reference to FIG. 6. When this block is not included within the flow chart 325, a user may either enable or disable a travel profile as described with reference to FIG. 2B. In block 510, it is determined whether the travel profile 190 is enabled, or activated. As mentioned above, a user may set the toggle 222 either to disabled or enabled (see FIG. 2B). To complete block 510, the status of this toggle may be determined. If the travel profile 190 is not enabled (i.e., toggle 222 is set to disabled), the process proceeds to block 550, which is subsequently described below.

If the travel profile 190 is enabled (i.e., toggle 222 is set to enabled), then in the block 515, it is determined whether the stored number begins with a “+”. As mentioned above, a home area prefix (HAP) may be a collection of alphanumeric characters or symbols placed before the telephone number that are used in satisfying dialing conventions in the calling area from which the call is being initiated. The HAP may include an international dialing symbol portion, a regional portion, an international dialing portion and a regional portion, or some combination thereof. For example, the “+” symbol may be an international dialing symbol for the mobile electronic device 100. In an alternative embodiment, the international dialing symbol may be some other symbol, such as an *, &, or some other suitable symbol. The regional portion can be any type of geographically-based dialing code, such as an area code or country code. Hence, in block 515, the location dialing software 192 assesses whether there is an international dialing symbol + that precedes the telephone number. In other words, it is assessed whether a user previously entered the stored telephone number with the international dialing symbol + into the mobile electronic device 100. If the stored telephone number does begin with the international dialing symbol +, then the process proceeds to block 550, which is subsequently described below.

If the stored telephone number does not begin with a “+”, then in block 520, it is determined if the Home Area Prefix (HAP) begins with “+”. As mentioned above, the HAP may include simply the regional portion, a combination of a regional portion and an international dialing symbol, or simply an international dialing symbol. For example, the HAP may be a +1, +1770, or simply 770. If the HAP does not begin with a “+,” then in block 525, it is determined whether the HAP matches the most significant digits of the stored telephone number identified at block 505. In other words, it is assessed whether any additional characters stored at the time the user stored the telephone number match the HAP. If the most significant digits of the stored telephone number do match the HAP, the process proceeds to block 550, which is subsequently described. In this case, dialing may proceed normally because the HAP begins with the international dialing symbol (block 520) and the entire HAP is included (block 525).

If it is determined in block 525 that the most significant digits of the stored telephone number did not match the HAP, then in block 530, the full HAP is added to the preceding stored number. The process then continues at block 550. If it is determined in block 520 that the home area prefix (HAP) does not start with a “+,” then in block 535, it is determined if the HAP after the “+” (i.e., the regional portion) matches the most significant digits of the stored telephone number. When the regional portion of the HAP does match the most significant digits of the stored telephone number, the international dialing symbol + is added at block 540. In contrast, the full HAP is added to the stored number at block 545 when the regional dialing portion does not match the most significant digits.

In block 550, the location dialing software 192 transmits dialing instructions. More specifically, dialing instruction signals are transmitted to the microprocessor 126 on connection 162 (See FIG. 1). The microprocessor 126 produces corresponding dialing signals, as previously described, which result in a call being placed.

FIG. 6 is a flow chart 507 illustrating the optional profile selection subroutine of FIG. 5. As described above, this optional subroutine may be used in prompting a user to either enable or disable the travel profile 190. In block 610, the current network location is identified based on the geographical location of the mobile electronic device 100. In other words, it is determined whether the mobile electronic device 100 is located within a home calling area. It is then determined whether the current network is within the home area prefix (HAP) and whether the travel profile 190 is enabled. If both of these conditions are met, the travel profile selection menu 220 is displayed in block 620. Thus, a user is prompted to disable the travel profile 190 since the mobile electronic device 100 is within the home calling area. Otherwise, it is determined in block 625 whether the current network is outside of the HAP and the travel profile 190 is disabled. When both of these conditions occur, the process continues to block 620 as previously described. Thus, a user is prompted to enable the travel profile 190 since the mobile electronic device 100 is outside of the home calling area. Otherwise, the process ends.

The mobile electronic device 100 creates substantial advantages including increasing device efficiency. More specifically, the mobile electronic device 100 enables users to efficiently dial any number stored within this device's telephone book, despite the geographical region where the device is used, without dialing extra characters when the call is being placed. Either enabling or disabling the travel profile selections can change how all incoming and outgoing calls are handled without having to change entries in the telephone book 191. In addition, users may improve efficiency with the mobile electronic device 100 by defining numerous travel profiles for regions most frequented. Finally, the mobile electronic device 100 increases efficiency, while potentially decreasing costs associated with device usage, by enabling selective answering of calls. Users can determine whether a call should be answered using the call identification functionality and potentially avoid increased call charges associated with answering unwanted calls.

While various embodiments of the invention have been described, it may be apparent to those of ordinary skill in the art that many more embodiments and implementations are possible that are within the scope of this invention. For example, while illustrated using a portable communication handset or a PDA, the invention is applicable to any mobile electronic device. All such modifications are intended to be included within the scope of this disclosure and the present invention and protected by the following claims.

What is claimed is:

1. A method for dialing a telephone number stored in a mobile electronic device when the mobile electronic device is away from a home calling area, the method comprising:
defining a travel profile for a location with an associated home area prefix;
determining whether the travel profile is enabled;
determining whether the telephone number includes the home area prefix when the travel profile is enabled;
adding characters to the telephone number, wherein adding creates a modified telephone number when it is determined that the telephone number does not include the home area prefix; and
dialing the modified telephone number.

2. The method of claim 1, further comprising dialing the telephone number when the travel profile is not enabled.

3. The method of claim 2, further comprising dialing the telephone number when it is determined that the telephone number does not include the home area prefix.

4. The method of claim 1, further comprising enabling the travel profile when the mobile electronic device is away from the home calling area and disabling the travel profile when the mobile electronic device is within the home calling area.

5. The method of claim 1, further comprising:
receiving an incoming number associated with an incoming telephone call;
determining whether a number of comparison digits associated with least significant digits for the incoming number correspond to least significant digits for the telephone number; and
displaying identifying information when the least significant digits for the incoming number correspond to the least significant digits for the telephone number.

6. The method of claim 5, wherein the number of comparison digits is user-selected.

7. The method of claim 1, wherein determining whether the telephone number includes a home area prefix, further comprises determining whether the telephone number includes an international dialing symbol portion of the home area prefix, and determining whether the telephone number includes a regional portion of the home area prefix.

8. The method of claim 6, wherein adding characters to the telephone number comprises adding the international dialing symbol portion of the home area prefix when it is determined that the home area prefix does not include the international dialing symbol portion, and adding the regional portion of the home area prefix when it is determined that the home area prefix does not include the regional portion.

9. A system for dialing a telephone number stored in a mobile electronic device when the mobile electronic device is away from a home calling area, comprising:
a memory element for storing the telephone number, a travel profile, and location dialing software, wherein the location dialing software is operable for prompting the memory element to generate dialing instruction signals associated with the travel profile;
a microprocessor operatively coupled to receive the dialing instruction signals from the memory element, wherein the microprocessor generates dialing signals in response to receiving the dialing instruction signals; and
a transceiver element coupled to receive the dialing signals and operable for dialing the telephone number when the mobile electronic device is in a location, other than the home calling area.

10. The system of claim 9, wherein the memory element further comprises a non-volatile portion and the travel profile is stored in the nonvolatile portion of the memory.

11. The system of claim 9, wherein the memory element further comprises a telephone book for storing the telephone number.

12. The system of claim 9, wherein the transceiver element is operable for receiving an incoming call and the location dialing software is operable for generating identification instruction signals in response to processing the incoming call, wherein the microprocessor transmits display signals in response to processing the identification instruction signals.

13. The system of claim 11, further comprising a display coupled to receive the display signals from the microprocessor and operable for displaying identifying information in response to receiving the display signals.

14. A computer-readable medium having a program for dialing a telephone number stored in a mobile electronic device when the mobile electronic device is away from a home calling area, the program comprising logic configured to perform:
defining a travel profile for a location with an associated home area prefix;
determining whether the travel profile is enabled;
determining whether the telephone number includes the home area prefix when the travel profile is enabled;
adding characters to the telephone number, wherein adding creates a modified telephone number when it is determined that the telephone number does not include the home area prefix; and
dialing the modified telephone number.

15. The computer-readable medium of claim 14, further comprising dialing the telephone number when the travel profile is not enabled.

16. The computer-readable medium of claim 15, further comprising dialing the telephone number when it is determined that the telephone number does not include the home area prefix.

17. The computer-readable medium of claim 14, further comprising enabling the travel profile when the mobile electronic device is away from the home calling area and disabling the travel profile when the mobile electronic device is within the home calling area.

18. The computer-readable medium of claim 14, further comprising:
receiving an incoming number associated with an incoming telephone call;
determining whether a user-selected number of comparison digits associated with least significant digits for the incoming number correspond to least significant digits for the telephone number; and
displaying identifying information when the least significant digits for the incoming number correspond to the least significant digits for the telephone number.

19. The computer-readable medium of claim 14, wherein determining whether the telephone number includes a home area prefix, further comprises determining whether the telephone number includes an international dialing symbol portion of the home area prefix, and determining whether the telephone number includes a regional portion of the home area prefix.

20. The computer-readable medium of claim 19, wherein adding characters to the telephone number comprises adding the international dialing symbol portion of the home area prefix when it is determined that the home area prefix does not include the international dialing symbol portion, and adding the regional portion of the home area prefix when it is determined that the home area prefix does not include the regional portion.
